(19) United States
(12) Patent Application Publication
(10) Pub. No.: US 2015/0116502 A1
(43) Pub. Date: Apr. 30, 2015

(54) APPARATUS AND METHOD FOR DYNAMICALLY SELECTING MULTIPLE CAMERAS TO TRACK TARGET OBJECT

(71) Applicant: Electronics and Telecommunications Research Institute, Daejeon-si (KR)

(72) Inventors: Gi-Mun UM, Daejeon-si (KR); Il-Gu JUNG, Daejeon-si (KR); Won RYU, Seoul (KR)

(73) Assignee: Electronics and Telecommunications Research Institute, Daejeon-si (KR)

(21) Appl. No.: 14/497,843

(22) Filed: Sep. 26, 2014

(30) Foreign Application Priority Data
Oct. 31, 2013 (KR) 10-2013-0131645

(51) Int. Cl. G01S 3/786; H04N 13/02

(52) U.S. Cl. CPC G01S 3/7864; H04N 13/0275
USPC 348/169

(57) ABSTRACT

A method for dynamically selecting multiple cameras to track a target object, the method including selecting a main camera from among multiple cameras; selecting a target object from an image captured by the main camera; projecting a captured location of the target object onto images to be captured by one or more sub cameras; and selecting sub cameras according to a pixel proportion that indicates a number of pixels which are included in a capture location of the target object in the images captured by the one or more sub cameras.

### CROSS-REFERENCE TO RELATED APPLICATION(S)

This application claims the benefit under 35 U.S.C. §119(a) of Korean Patent Application No. 10-2013-0131645, filed on Oct. 31, 2013, in the Korean Intellectual Property Office, the entire disclosure of which is incorporated herein by references for all purposes.

### BACKGROUND

1. Field

The present invention relates to a broadcasting service apparatus using multiple cameras and a method thereof, and more particularly, to an apparatus and method for providing a service by capturing an object of interest with multiple cameras.

2. Description of the Related Art

U.S. Patent Publication No. 2012-0154593, titled “METHOD AND APPARATUS FOR RELATIVE CONTROL OF MULTIPLE CAMERAS”, introduces a technique of using multiple cameras for a broadcasting service. This invention relates to a method and apparatus for controlling a plurality of cameras to capture footage of a sporting event, and is characterized such that one camera tracks an object of interest while the other camera captures surroundings of the object of interest, for example, a stadium.

This invention provides only a function of adjusting a location or a field of view of other cameras according to a location of a tracked object of interest in order to capture the surroundings of the tracked object of interest. That is, this invention is not able to provide footage of an object of interest, which is captured at various angles.

In addition, when the object of interest moves out of a field of view of a fixed camera, accuracy in tracking the object of interest is reduced.

Moreover, when there are many objects with similar colors, an error may occur when tracking one of the objects.

### SUMMARY

In one general aspect, there is provided a method for dynamically selecting multiple cameras to track a target object, the method including: selecting a main camera from among multiple cameras; selecting a target object from an image captured by the main camera; projecting a captured location of the target object onto images to be captured by one or more sub cameras; and selecting sub cameras according to a pixel proportion that indicates a number of pixels which are included in a capture location of the target object in the images captured by the one or more sub cameras.

The selecting of sub cameras may be repeatedly performed at each frame or at predetermined frame intervals.

The method may further include calculating a camera parameter that indicates a location and a position of each of the multiple cameras.

The calculating of a camera parameter may include updating the camera parameter when at least one of factors including position, zoom setting and focus of a camera is changed while the target object is being captured.

The projecting of a captured position of the target object may include extracting an area of the target object from the image captured by the main camera, and calculating a capture location of the target object, which corresponds to an area of the target object, based on the camera parameter.

The extracting of an area of the target object may include obtaining color and depth information of the target object in the image captured by the main camera based on an approximate location of the target object; and extracting the area of the target object from the image captured by the main camera based on the obtained color and depth information

The extracting of an area of the selected target object may include extracting the area of the target object simply based on color information in a case where the multiple cameras are PTZ cameras.

The method may further include generating a three-dimensional (3D) model of the target object on a basis of frame unit by projecting color and depth information of the target object in the image captured by the main camera in a 3D space and performing registration on the projected color and depth information.

In another general aspect, there is provided an apparatus for dynamically selecting multiple cameras to track a target object, the apparatus including: a main camera selector configured to select a main camera from among multiple cameras; a target object selector configured to select a target object from an image captured by the main camera; a target object projector configured to project a capture location of the target object onto images to be captured by one or more sub cameras; and a sub camera selector configured to select sub cameras according to a pixel proportion that indicates a number of pixels which are included in the projected capture location of the target object in the images captured by the one or more sub cameras.

The multiple cameras may be three-dimensional (3D) cameras.

Each of the target object projector and the sub camera selector may be configured to perform operations at each frame or in predetermined frame intervals.

The apparatus may further include a camera parameter calculator configured to calculate a camera parameter that indicates a location and a position of each of the multiple cameras.

The camera parameter calculator may be further configured to update the camera parameter when at least one of factors including a camera's position, zoom setting, and focus is changed while the target object is being captured.

The target object projector may be further configured to comprise: a target object area extractor configured to extract an area of the target object from the image captured by the main camera; and a projection coordinate calculator configured to calculate the capture location of the target object, which corresponds to the extracted area of the target object.

The target object area extractor may be further configured to obtain color and depth information of the target object in the image captured by the main camera based on an approximate location of the target object, and to extract an area of the target object from the image captured by the main camera based on the obtained color and depth information.

The target object projector may be further configured to comprise a projection coordinate transmitter configured to transmit the calculated coordinates to the multiple cameras.

The target object extractor may be further configured to extract the area of the target object from the image simply based on color information in the case where the multiple cameras are PTZ cameras.

The apparatus may further include a 3D model part configured to generate a 3D model of the target object on a basis of frame unit by projecting color and depth information of the extracted area of the target object in the image captured by the main camera in a 3D space, and performing registration on the projected color and depth information.

Other features and aspects may be apparent from the following detailed description, the drawings, and the claims.

### BRIEF DESCRIPTION OF THE DRAWINGS

FIG. 1 is a diagram illustrating an example of dynamically selecting multiple cameras to track a target object according to an exemplary embodiment;

FIG. 2 is a diagram illustrating a configuration of an apparatus for dynamically selecting multiple cameras to track a target object according to an exemplary embodiment; and

FIG. 3 is a flow chart illustrating a method for dynamically selecting multiple cameras to track a target object according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

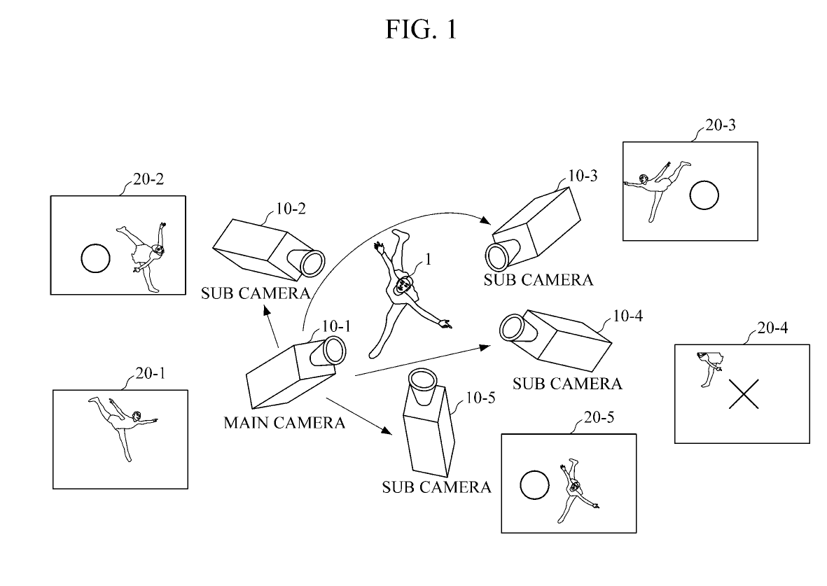

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. FIG. 1 is a diagram illustrating an example of dynamically selecting multiple cameras to track a target object according to an exemplary embodiment.

Referring to FIG. 1, a plurality of cameras 10-1, 10-2, 10-3, 10-4 and 10-5 are arranged around a target object 1 at different angles to capture the target object 1. There is no limitation on the number of multiple cameras as long as the cameras are able to capture the target object 1 at different angles. The multiple cameras may be used as a main camera 10-1 and as sub cameras 10-2, 10-3, 10-4 and 10-5, and such settings of the multiple cameras may be determined by a user.

A location of a target object included in an image 20-1 captured by the main camera 10-1 is projected onto images to be captured by the sub cameras 10-2. 10-3, 10-4 and 10-5. Being projected onto the images captured by the sub cameras 10-2. 10-3, 10-4 and 10-5, the location of the target object may exist within a field of view of each of the sub cameras. However, all the cameras may not be arranged and located by taking into consideration the location of the target object. In addition, as the target object moves, all or some of the pixels of the target object in an image captured by a specific sub camera may be out of a field of view of the specific sub camera. For example, in FIG. 1, only some of the pixels of the target object is included in the image captured by the sub camera 10-4. In such a case, it is inefficient to capture the object of the interest using the sub camera 10-4. Therefore, the target object 1 is tracked using only the sub cameras 10-2, 10-3 and 10-5, all of which has the number of within-field-of-view pixels of a target object corresponds to or is greater than a specific pixel proportion.

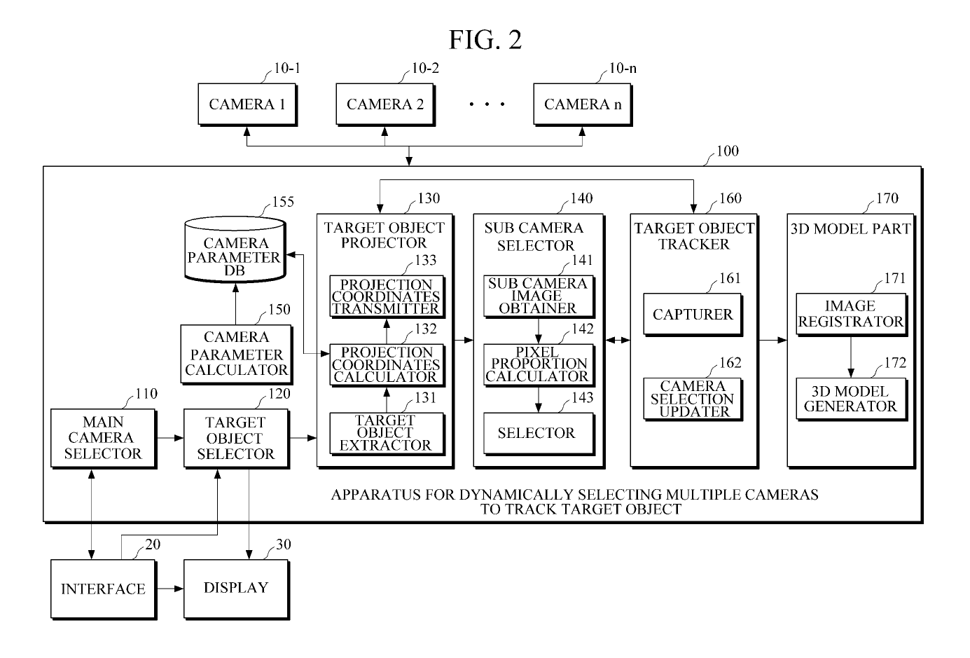

FIG. 2 is a diagram illustrating a configuration of an apparatus for dynamically selecting multiple cameras to track a target object according to an exemplary embodiment.

Referring to FIG. 2, an apparatus 100 for dynamically selecting multiple cameras to track a target object includes a main camera selector 110, a target object selector 120, a target object projector 130 and a sub camera selector 140. Additionally, the apparatus 100 may further include a camera parameter calculator 150, a camera parameter DB 155, a target object tracker 160, and a three-dimensional (3D) model part 170.

Multiple cameras 10-1, 10-2, . . . , 10-n indicates a plurality of cameras used to capture a target object at different angles, and may include a PTZ camera with a pan function, a tilt function and a zoom function according to an exemplary embodiment. In addition, in this present disclosure, multiple 3D cameras are used, instead of multiple cameras that obtains only color video. Herein, a 3D camera refers to a device that is able to obtain a distance or depth to a color image. The 3D camera includes a stereo camera, a depth sensor capable of obtaining a depth in real time, and so on.

Before the beginning of imaging, the multiple cameras 10-1, 10-2, . . . , 10-n are appropriately arranged around a target object in order to capture the target object at different angles. In addition, as having a pan function, a tilt function and a zoom function, a PTZ camera controls the target object to have suitable size and location for an image to be captured. The multiple cameras 10-1, 10-2, . . . , 10-n may be connected to the apparatus through a wired/wireless communication means.

The main camera selector 110 selects a main camera from among the multiple cameras 10-1, 10-2, . . . , 10-n. Specifically, a main camera may be designated by a user through an interface 20. Herein, the interface 20 may be any available means for receiving information from a user, including a microphone and a touch screen. The interface 20 may be connected to the apparatus 100 through a wired/wireless communication means.

The target object selector 120 selects a target object from an image captured by the selected main camera. That is, the target object selector 120 may display on a display 30 the main camera's captured image, and receive a user's selection of the target object through the interface 20. Herein, the display 30 may be a display means for outputting a still image or a video signal, including Liquid Crystal Display (LCD), and may be provided in the apparatus 100 or connected to the apparatus 100 through a wired/wireless communicator.

The target object projector 130 projects a captured location of a target object onto an image to be captured by each sub cameras. Specifically, the target object projector 130 includes an object area extractor 131, a projection coordinate calculator 132 and a projection coordinate transmitter 133.

The object area extractor 131 extracts an area of the target object from the image captured by the main camera. Specifically, the object area extractor 131 obtains color and depth information of the target object in the image captured by the main camera based on an approximate location of the target object included in the image, and extracts the area of the target object from the image. When PTZ cameras are used, the object area extractor 131 may extract the area of the target object simply based on color information, since the PTZ cameras is not capable of obtaining depth information from an image.

Based on depth information of each pixel in the extracted area of the target object and each camera parameter, the projection coordinate calculator 132 calculates coordinates that is to be three-dimensionally projected onto an image to be captured by a sub camera. Herein, a camera parameter indicates a location and a position of each of the multiple cameras, and is a value calculated by the camera parameter calculator 150.

The camera parameter calculator 150 calculates a camera parameter that indicates a location and a position of each of multiple cameras. When calculating the camera parameter, the camera parameter calculator 150 may employ a technique titled “A Flexible New Technique for Camera Calibration” which was introduced by Z. Z. Zhang in IEEE Transactions on Pattern Analysis and Machine Intelligence, 22(11): 1330-1334, 2000. In addition, in the case where fixed cameras are used, a location of the camera does not change. However, in the case where PTZ cameras are used, if factors including position, zoom setting and focus of a camera are changed while the target object is being captured, the camera parameter calculator 150 calculates a camera parameter again. When updating the camera parameter, the camera parameter calculator 150 may utilize a self-calibration technique titled “Camera self-calibration: Theory and experiments” which was proposed by O. D. Faugeras, Q. T. Luong, and S. J. Maybank in In G. Sandini, editor, Proc. 2nd European Conf. On Comp Vision, Lecture Notes in Comp. Science 588, pp. 321-334. Springer-Verlag, May 1992. A camera parameter calculated by the camera parameter calculator 150 may be stored in the camera parameter DB 155.

Thus, the projection coordinate calculator 132 may notify a relative location relationship between cameras using a camera parameter stored in the camera parameter DB 155. That is, when a camera A obtains 3D information about a point included in an image captured by the camera A, it is possible to calculate a location of the same point in an image captured by a camera B.

The projection coordinate transmitter 133 transmits the calculated projection coordinates to each sub camera.

The projection coordinates transmitted to each of sub cameras may exist within a field of view thereof, but chances are that all or some of the pixels of the target object in an image captured by a specific sub camera may be out of a field of view of the specific sub camera, since all the cameras are not necessarily arranged or positioned by taking into consideration a location of the target object.

The sub camera selector 140 selects sub cameras according to a pixel proportion of the target object in an image captured by each of the sub cameras. The sub camera selector 140 includes a sub camera image obtainer 141, a pixel proportion calculator 142 and a selector 143.

The sub camera image obtainer 141 obtains a captured image from one or more sub cameras. The pixel proportion calculator 143 calculates a pixel proportion of the target object included in the captured image. The selector 143 dynamically selects sub cameras according to a pixel proportion that is calculated by the pixel number calculator 142. That is, in the case where the number of pixels of a target object being out of a field of a sub camera corresponds to or is greater than a specific pixel proportion, a determination is made that the target object is out of the field of view of the sub camera, and thus, the sub camera is excluded from capturing the target object. For example, as illustrated in FIG. 1, the sub camera 10-4 with a pixel proportion below a specific pixel proportion is excluded from capturing the target object.

After sub cameras are selected enabled to track the target object and a user inputs a request for tracking the target object, the target object tracker 160 tracks the object of the interest. Specifically, the target object tracker 160 includes a capturer 161 and a camera selection updater 162.

In response to the request for tracking a target object, the capture 161 obtains an image captured by the main camera and images captured by sub cameras selected by sub camera selector 140, and then displays the obtained images on a display 30. At this point, in association with the target object projector 130, the capturer 161 extracts an area of the target object from the main camera's captured image based on color and depth information of a target object with respect to the image captured by the main camera. Then, based on the extracted area of the target object, the capturer 161 calculates coordinates that are to be three-dimensionally projected onto images to be captured by the selected sub cameras, and transmits the calculated coordinates to the selected sub cameras. Then, the selected sub cameras capture the object of the interest based on the calculated coordinates.

However, the target object moves and a location thereof is changed over time, so a process of selecting sub cameras enabled to capture the target object needs to be performed again. To this end, in association with the sub camera selector 140, the camera selection updater 162 selects sub cameras again. The selection of sub cameras may be performed at each frame or in predetermined frame intervals by taking into account processing time.

In addition, the target object tracker 160 may perform operations until receiving a command for terminating capturing the target object, and may terminate operations upon a main camera change request or a target object change request. That is, in response to the main camera change request or the target object change request, the target object tracker 160 may start to track a target object after initialization operations are performed by the target object projector 130 and the sub camera selector 140.

The 3D model part 170 generates a 3D model of the target object on the basis of frame unit by projecting color and depth information of the target object in an image captured by each of multiple 3D cameras, in a 3D space, and performing registration on the projected color and depth information. Then, the 3D model part 170 generates a virtual image, not from a field of view of a camera, but from a different viewpoint based on the generated 3D model, so that it is possible to continuously provide object-centric images from multiple viewpoints.

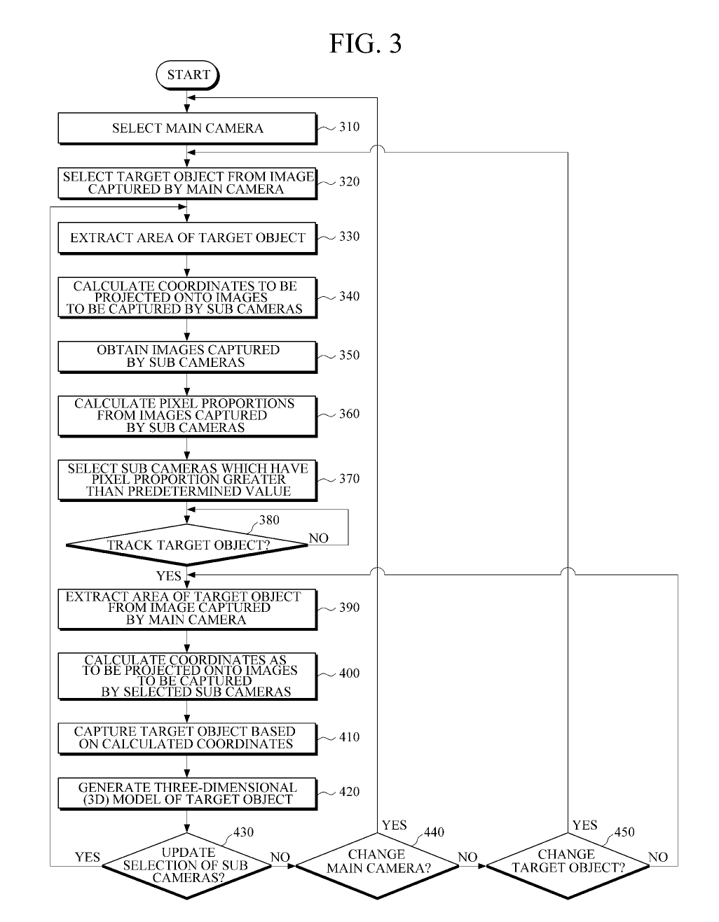

FIG. 3 is a flow chart of a method for dynamically selecting multiple cameras to track a target object according to an exemplary embodiment.

Before capturing, multiple the multiple cameras 10-2, 10-2, . . . , 10-n are appropriately arranged around a target object in order to capture the target object at different angles. In the case where PTZ cameras are used, the target object is controlled to have suitable size and location for an image to be captured, since the PTZ cameras have a pan function, a tilt function and a zoom function

Referring to FIG. 3, in operations 310, the main camera selector 110 selects a main camera from among the multiple cameras 10-1, 102, . . . , 10-n. At this point, a main camera may be designated by a user.

In operations 320, the target object selector 120 selects a target object from an image captured by the main camera. That is, the target object selector 120 may display an image captured by the main camera, and may receive a user's selection for a target object.

The target object projector 130 projects a capture location of the target object onto an image captured by one or more sub cameras. Specifically, in operations 330, the target object area extractor 131 extracts an area of the target object from an image captured by the main camera. More specifically, the target object area extractor 131 obtains color and depth information of the target object in the main camera′ captured image based on an approximate location of the target object, and extracts an area of the target object from the main camera's captured image based on the obtained color and depth information. However, a PTZ camera may extract an area of the target object from the main camera's captured image simply based on color information, since the PTZ camera is not capable of obtaining depth information.

In operations 340, using depth information of pixels in the extracted area of the target object and each camera parameter, the projection coordinate calculator 132 calculates coordinates that are to be three-dimensionally projected onto an image to be captured by a sub camera. A camera parameter indicates a location and a position of each of the multiple sub cameras, and is a value that is calculated in advance. In the case when fixed camera are used, a location of a camera is not changed. However, in the case when PTZ cameras are used, if factors including a camera's position, zoom setting and a focus are changed, an operations of re-calculating a camera parameter may be further included, although it is not illustrated in FIG. 3.

Accordingly, the projection coordinate calculator 132 may identify a relative location relationship between cameras using camera parameters thereof. That is, if 3D information of a point in an image captured by a camera A is obtained, it is possible to calculate a location of the same point in an image captured by a camera B using a 3D projection scheme.

Coordinates projected onto images captured by sub cameras may be within a field of view of the sub cameras, but chances are that all or some of the pixels of a target object in an image captured by a specific sub camera may be out of the field of view of the sub camera, since all the camera are not necessarily arranged by taking into account locations of all the cameras and a location of the target object.

Accordingly, the sub camera selector 140 selects sub cameras according to a pixel proportion of a target object in an image captured by each of the sub cameras. Specifically, in operations 350, the sub camera image obtainer 141 obtains images captured by one or more sub cameras. In operation 360, the pixel proportion calculator 142 calculates a pixel proportion of the target object in the image captured by each of the sub camera. In operation 370, the selector 143 dynamically selects sub cameras according to a pixel proportion of the target object in the image captured from each of the sub cameras. That is, when the number of out-of-field-of-view pixels of a target object corresponds to or is greater than a specific pixel proportion (e.g., 30%), a determination may be made that the target object is out of the field of view, and thus, the specific sub camera is excluded from capturing the target object.

After sub cameras enable to track the target object, the target object tracker 160 determines, in operation 380, whether a target object tracking request is received from a user.

In response to a determination made in operation 380 that the target object tracking request that is received from the user, the capturer 161 obtains an image from a main camera and images from sub cameras selected by the sub camera selector 140. At this point, in association with the target object projector 130, the capture 161 extracts an area of the target object from the image captured by the main camera based on color and depth information of the target object in the image captured by the main camera in operation 390. In operation 400, the capture 161 calculates coordinates that are to be three-dimensionally projected onto an image to be captured by each of the selected sub cameras. In operation 410, the capture 161 captures the target object using the selected sub cameras based on the calculated coordinates.

Selectively, in operation 420, the 3D model part 170 generates a 3D model of the target object on the basis of frame unit by projecting color and depth information of the target object in an image captured by each of the selected sub cameras in a 3D space, and then performing registration on the projected color and depth information. Accordingly, the 3D model part 170 may generate a virtual image, not from a field of view of a camera, but from a different viewpoint, so that object-centric images of multiple viewpoints may be provided continuously.

However, the target object moves and a location thereof is changed over time, so sub cameras enabled to capture the target object needs to be selected again. To this end, in operation 430, the camera selection updater 162 determines whether to update selection of sub cameras. At this point, a determination is set to be made at each frame or at predetermined frame intervals by taking into consideration processing time. Alternatively, such a determination may be made upon a request from a user.

In response to a determination made in operation 430 that selection of sub cameras needs to be updated, the camera selection updater 162 works in association with the sub camera selector 140 to proceed with operation 330.

The target object tracker 160 perform operations until receiving a request for terminating capturing the target object, and may finish the operations upon a main camera change request or a target object change request. That is, in response to the main camera change request in operation 440 or the target object change request in operation 450, the target object tracker 160 may controls operation 310 or operation 320, respectively, to be proceeded with.

Those who are skilled in the related art may understand that various and specific modifications may be made without modifying the technical ideas or essential characteristics of the invention. Accordingly, the embodiments disclosed above are exemplary, and should be understandable not to be limited to in all aspects.

What is claimed is:

1. A method for dynamically selecting multiple cameras to track a target object, the method comprising:
selecting a main camera from among multiple cameras;
selecting a target object from an image captured by the main camera;
projecting a captured location of the target object onto images to be captured by one or more sub cameras; and
selecting sub cameras according to a pixel proportion that indicates a number of pixels which are included in a capture location of the target object in the images captured by the one or more sub cameras.

2. The method of claim 1, wherein the selecting of sub cameras is repeatedly performed at each frame or at predetermined frame intervals.

3. The method of claim 1, further comprising:
calculating a camera parameter that indicates a location and a position of each of the multiple cameras.

4. The method of claim 3, wherein the calculating of a camera parameter comprises updating the camera parameter when at least one of factors including position, zoom setting and focus of a camera is changed while the target object is being captured.

5. The method of claim 3, wherein the projecting of a captured position of the target object comprises:
extracting an area of the target object from the image captured by the main camera, and
calculating a capture location of the target object, which corresponds to an area of the target object, based on the camera parameter.

6. The method of claim 5, wherein the extracting of an area of the target object comprises
obtaining color and depth information of the target object in the image captured by the main camera based on an approximate location of the target object; and
extracting the area of the target object from the image captured by the main camera based on the obtained color and depth information

7. The method of claim 1, wherein the extracting of an area of the selected target object comprises
extracting the area of the target object simply based on color information in a case where the multiple cameras are PTZ cameras.

8. The method of claim 1, further comprising:
generating a three-dimensional (3D) model of the target object on a basis of frame unit by projecting color and depth information of the target object in the image captured by the main camera in a 3D space and performing registration on the projected color and depth information.

9. An apparatus for dynamically selecting multiple cameras to track a target object, the apparatus comprising:
a main camera selector configured to select a main camera from among multiple cameras;
a target object selector configured to select a target object from an image captured by the main camera;
a target object projector configured to project a capture location of the target object onto images to be captured by one or more sub cameras; and
a sub camera selector configured to select sub cameras according to a pixel proportion that indicates a number of pixels which are included in the projected capture location of the target object in the images captured by the one or more sub cameras.

10. The apparatus of claim 9, wherein the multiple cameras are three-dimensional (3D) cameras.

11. The apparatus of claim 9, wherein each of the target object projector and the sub camera selector is configured to perform operations at each frame or in predetermined frame intervals.

12. The apparatus of claim 9, further comprising:
a camera parameter calculator configured to calculate a camera parameter that indicates a location and a position of each of the multiple cameras.

13. The apparatus of claim 12, wherein the camera parameter calculator is further configured to update the camera parameter when at least one of factors including a camera's position, zoom setting, and focus is changed while the target object is being captured.

14. The apparatus of claim 12, wherein the target object projector is further configured to comprise:
a target object area extractor configured to extract an area of the target object from the image captured by the main camera; and
a projection coordinate calculator configured to calculate the capture location of the target object, which corresponds to the extracted area of the target object.

15. The apparatus of claim 14, wherein the target object area extractor is further configured to obtain color and depth information of the target object in the image captured by the main camera based on an approximate location of the target object, and to extract an area of the target object from the image captured by the main camera based on the obtained color and depth information.

16. The apparatus of claim 14, the target object projector is further configured to comprise
a projection coordinate transmitter configured to transmit the calculated coordinates to the multiple cameras.

17. The apparatus of claim 15, wherein the target object extractor is further configured to extract the area of the target object from the image simply based on color information in the case where the multiple cameras are PTZ cameras.

18. The apparatus of claim 9, further comprising:
a 3D model part configured to generate a 3D model of the target object on a basis of frame unit by projecting color and depth information of the extracted area of the target object in the image captured by the main camera in a 3D space, and performing registration on the projected color and depth information.
